(19) United States
(12) Patent Application Publication
(10) Pub. No.: US 2018/0208731 A1
(43) Pub. Date: Jul. 26, 2018

(54) Green Form Expandable Polystyrene Resin

(71) Applicant: Ravi Kishore Vankayala, Faridabad (IN)

(72) Inventor: Ravi Kishore Vankayala, Faridabad (IN)

(21) Appl. No.: 15/744,837

(22) PCT Filed: Jul. 13, 2016
(86) PCT No.: PCT/IN2016/050238

§ 371 Date: Jan. 15, 2018

(30) Foreign Application Priority Data
Jul. 15, 2015 (IN) 2143/DEL/2015

(51) Int. Cl. C08J 9/00; C08J 9/228; B29C 44/34

(52) U.S. Cl. CPC C08J 9/0061; C08J 9/228; B29C 44/3461; B29K 2025/06; C08J 2300/00; C08J 2325/06; C08J 2425/06; C08J 2201/03

(57) ABSTRACT

The present invention relates to a method of preparing green form polystyrene resin. More specifically, recyclable expandable material from general waste is made use of along with virgin expandable material and virgin hardening polymer for preparing green form polystyrene resin. Further, extruding the mixture yields green form compounded polystyrene resin with high melt flow index or gas injection into the green form compounded polystyrene resin results in synthesis of green form expandable capsules or beads thereof with desired properties. The present invention further facilitates the production of polystyrene molded foam used for insulation by puffing expandable green form capsules with pre-expander.

### FIELD OF INVENTION

Present invention relates to method of preparation of green form polystyrene with desired properties to use in varied applications promoting green technologies by reusing the used plastic. In specific the method of preparation comprises of using compounds like general purpose polystyrene (GPPS), recycled polystyrene (plastic waste) and with minimal amount of expandable polystyrene (EPS) to obtain green form polystyrene with increased melt flow index (MFI) and there by after gas injection it will give tendency to expand as expandable polystyrene (eps) capsules termed as green form expandable polystyrene

### BACKGROUND OF THE INVENTION

Styrene, also known as vinyl benzene, is an aromatic compound that is produced in industrial quantities from ethyl benzene. The most common method of styrene production comprises the dehydrogenation of ethylbenzene, which produces a crude product of styrene and ethylbenzene. Polystyrene is an aromatic polymer produced from the styrene monomer. Polystyrene can be solid or foamed. General purpose polystyrene is clear, hard, and rather brittle. Polystyrene is one of the most widely used plastics. It is a rather poor barrier to oxygen and water vapour and has a relatively low melting point. Polystyrene can be naturally transparent, but can be coloured with colorants.

Expanded polystyrene (EPS) is well known and can be produced by combining an expandable gas, such as CO2, with polystyrene, such as during the production of foamed products and can include extruded polystyrene (XPS). EPS can be used in applications such as insulation material and thereof as the entrapped gaseous content resists the flow of heat thereby giving insulating properties.

By-products and excess amounts of polystyrene and polystyrene containing compositions are produced during the process of molding, shaping and producing the products containing polystyrene. Polystyrene plastics because of their good strength, extension, molding, thermal insulation properties, in the production and life are widely used. However, polystyrene products obtained after use, generally cannot be directly secondary use, and cannot be degraded after discarding rotten. These by-products, along with post commercial, post-consumer polystyrene products, often become waste that can end up in landfills or incinerators therefore, cause serious pollution to the environment. So it is desirable to recycle this material in order to prevent waste and pollution. It is also desirable to obtain polystyrene having improved tensile properties in order that a lesser amount of polystyrene may be needed in a given polystyrene product, which can result in an overall reduction in polystyrene waste.

More in particular, it relates to a process comprising the reduction in volume of expanded polystyrene by means of dissolution in a solvent, separation of the Insoluble components, the selective precipitation of polystyrene with an anti-solvent, the separation, drying and extrusion of the precipitated polystyrene, recovery by distillation and recycling of the solvent.

The fire-retardant insulation board is widely used in the construction industry, but the current high cost of raw materials for the production of fire-retardant insulation board, and there is the expansion ratio, low intensity, poor performance and toughness, low surface defects.

Currently, there are various prior art that describes about different techniques for preparation of polystyrene using combination of either recycled polystyrene, general purpose polystyrene (GPPS) or expandable polystyrene (EPS), recycled polystyrene or general purpose polystyrene (GPPS), expandable polystyrene (EPS) but the above prior art doesn't reduce the manufacturing cost to a greater level. In general when there is usage of plastic waste or used plastic there is a compromise on quality of end product or compromise on properties of the end product.

Expandable polystyrene (EPS) is expensive component when compared to recycled polystyrene and general purpose polystyrene (GPPS) so the high usage of expandable polystyrene (EPS) increases the overall end product cost.

Hence there is a need in the art to produce a polystyrene that can be formed by combining different compounds like recycled polystyrene, general purpose polystyrene (GPPS), with minimal amount of expandable polystyrene (EPS) by using different extrusion techniques thereby promoting green technologies. Capsules are formed by treating the pellets with injection blowing agents like gas and thereof. Further treating the capsules with steam to get a pre-puff that can be used as loose fill and moulding grade to enhance the melt flow index (MFI) of the polystyrene, to increase the strength of the material with low thermal conductivity.

### Objectives of the Invention

An object of the present invention is to provide a green form expandable polystyrene using combined compounds like recycled polystyrene, general purpose polystyrene (GPPS), with minimal amount of expandable polystyrene (EPS) for increasing the free or melt flow index (MFI)

An object of the present invention is to provide a green form expandable polystyrene with minimal cost and high strength.

The other object of the present invention is to provide green form expandable polystyrene can acts as a insulation means for sound and vibration and flame retardant.

The other object of the present invention is to provide green form expandable polystyrene can acts as a power saving medium.

The other object of the present invention is to provide green form expandable polystyrene can acts as a power booster.

The other object of the present invention is to utilize plastic waste or used plastic and thereby promoting green technology.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Present invention discloses a method of preparing green form polystyrene resin where the method comprises of steps which includes mixing desired quantities of compounds comprising of virgin expandable material, where the virgin expandable material can be a general purpose polymer (GPPS), virgin hardening polymer where virgin hardening material can be a expandable polystyrene (EPS), recyclable expandable material where the recyclable expandable material can be used polystyrene processed using process like extrusion process where the recycled polystyrene can utilized or waste plastic like used bottles and thereof. Other necessary recipes are added to the compound mixture. Thereby the compound mixture is processed through an extrusion process whereby the process yields green form compounded polystyrene with high melt flow index. Method of preparing green form polystyrene further discloses composition of compounds to be used where desired quantities of the compounds mixed can be varied, where the desired quantities can be in the range of following percentages whereby the general purpose polymer can be in the range 35 to 60, the expandable polystyrene can be in the range 1 to 20 and the recyclable polystyrene can be in the range 35 to 65 whereby the desired properties of the green form polymer is attained as per usage or application area. The ratio of percentage of virgin general purpose polymer, recyclable expandable material and expandable polystyrene contribute to increase in melt flow index of the green form polystyrene where the attained melt flow index can be more than 35 units and whereby varying the ratios in the mixture melt flow index can be varied where the melt flow index can be increased or reduced.

Further the present Invention discloses a method of preparing green form polystyrene beads comprising of steps which include mixing desired quantities of compounds comprising of virgin expandable material, virgin hardening polymer, recyclable expandable material and other required materials thereof. The compound mixture is processed through an extruding process where the mixture yields green form compounded polystyrene resin with high melt flow Index. Further using gas injection technique gas is injected into the green form expandable polystyrene resin to synthesize green form expandable capsules or beads thereof with desired properties.

Further also present invention discloses a method of preparing green form polystyrene beads comprising of steps which include mixing desired quantities of compounds comprising of virgin expandable material, virgin hardening polymer, recyclable expandable material and other required materials thereof. The compound mixture is processed through an extruding process where the mixture yields green form compounded polystyrene resin with high melt flow index. Further using gas injection technique gas is injected into the green form expandable polystyrene resin to synthesize green form expandable capsules or beads thereof with desired properties and thereby puffing expandable green form capsules with pre-expander to synthesize green polystyrene molded foam which can be used for applications like insulation of walls and thereby promoting green technology.

### DETAILED DESCRIPTION OF DRAWINGS

The accompanying drawings, which are incorporated in and constitute a part of the specification, illustrate an embodiment of the invention, and, together with the description, serve to explain the principles of the invention.

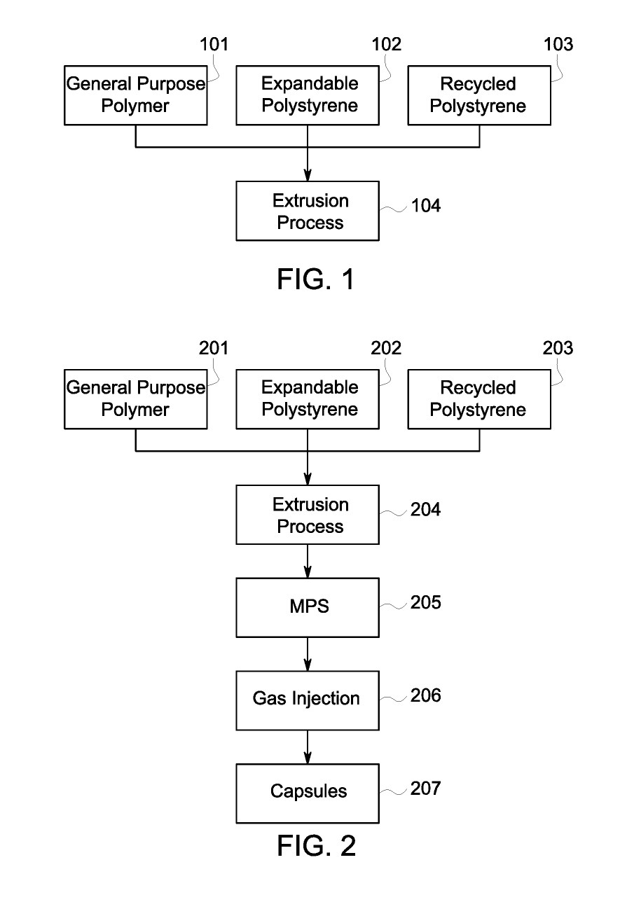

FIG. 1 shows the process of manufacturing of green foam polystyrene according one exemplary embodiment of the invention.

FIG. 2 shows the process of manufacturing of green foam polystyrene with injection of blowing agent according one exemplary embodiment of the invention.

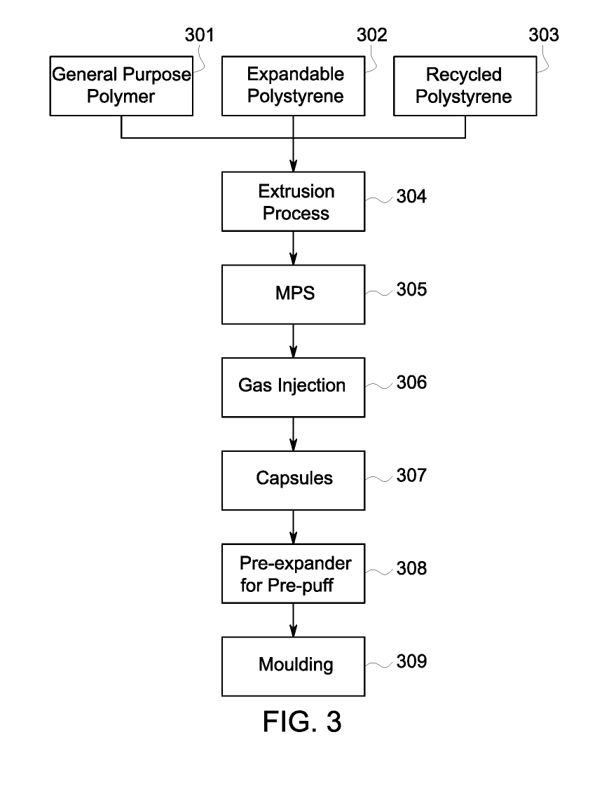

FIG. 3 shows the process of manufacturing of green foam polystyrene for treating of capsules in pre-expander for pre-puffing according one exemplary embodiment of the invention.

### DETAILED DESCRIPTION OF THE INVENTION

The present invention is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention is about the method of preparation of green form polystyrene with desired properties to use in varied applications promoting green technologies by reusing the used plastic for high melt flow index (MFI).

In specific the method of preparation comprises of using compounds like general purpose polystyrene (GPPS), recycled polystyrene (plastic waste) and with minimal amount of expandable polystyrene (EPS) to obtain green form polystyrene with increased melt flow index (MFI).

The method of manufacturing a green expandable polystyrene (EPS) or a polymer that can be formed by addition of different carbon containing and coloring composition like green color enhancer and thereof along with the recipe formulation uses different polymerization process like suspension and thereof for the production of green EPS. Where Suspension polymerization is a heterogeneous radical polymerization process that uses mechanical agitation to mix a monomer or mixture of monomers in a liquid phase, such as water, while the monomers polymerize, forming spheres of polymer. This process is used in the production of many commercial resins, including polyvinyl chloride (PVC), a widely used plastic, styrene resins including polystyrene, expanded polystyrene, and high-impact polystyrene, as well as poly(styrene-acrylonitrile) and poly(methyl methacrylate).

Like other polymers expandable materials can be recycled. Recycling of expandable material where the recyclable expandable material can be an expandable polystyrene where the recycling is a process of reusing the available polystyrene products that are generally available in different forms like bottles, packing's and thereof are processed using extrusion process and injecting gas into the extrusion for the preparation of capsules.

The virgin expandable material, where the virgin expandable material can be a general purpose polymer (GPPS)

According to an exemplary embodiment of the invention as shown in FIG. 1 describes about the method of preparing a green form polystyrene. Where a virgin expandable material 101 that can be a general purpose polymer (GPPS); virgin hardening polymer 102 where virgin hardening material can be an expandable polystyrene (EPS); recyclable expandable material 103 where the recyclable expandable material can be used polystyrene processed using process like extrusion process where the recycled polystyrene 103 can be obtained from utilized or waste plastic products like used bottles and thereof are mixed to form a compound mixture and other necessary recipes are also added to the compound mixture. Thereby the compound mixture is processed through extrusion process 104.

During exemplary extrusion process 104 the compound mixture with recipes are feeded into the hopper then the material undergoes compression and melting with predetermined temperature. The basics of foam extrusion consist of mixing a chemical foaming agent (CFA) with the polymer to be extruded. The heat generated to melt the polymer decomposes the chemical foaming agent resulting in gas being liberated. This gas is dispensed in the polymer melt and expands upon exiting the die. Basically, all common extruders can be used for foaming if the following requirements are met: The melt temperature must be high enough to guarantee a total decomposition of the foaming agent. The pressure of the melt must be kept high enough to keep the gas generated by the decomposition of the foaming agent dissolved in the polymer melt until the melt exits the extrusion die. If the melt temperature is too low, the decomposition of the foaming agent will be incomplete, resulting in an uneconomical process. And, un-decomposed foaming agent particles can lead to agglomerates, which can clog the melt filter or cause voids, poor cell structure, or poor surface appearance. A pressure profile that is not high enough can lead to “pre-foaming”. Even with a subsequent pressure increase, the gas cannot be “re-dissolved”, resulting in a large irregular cell structure with broken and collapsed cells. The coarse foam produced this way leads to holes in flat films, while profiles and sheets get a rough surface (shark skin); during blown film production, the blown film tubing can collapse.

According to another exemplary embodiment of the present invention as shown in FIG. 2 describes about the method of preparing a green form polystyrene beads or capsules. Where a virgin expandable material 201 that can be a general purpose polymer (GPPS); virgin hardening polymer 202 where virgin hardening material can be an expandable polystyrene (EPS); recyclable expandable material 203 where the recyclable expandable material can be used polystyrene processed using process like extrusion process where the recycled polystyrene 203 can utilized or waste plastic like used bottles and thereof are mixed to form a compound mixture and other necessary recipes are also added to the compound mixture. Thereby the compound mixture is processed through extrusion process 204 to obtain MPS 205. Using gas injection process 206 gaseous agents are injected into the MPS 205 to convert the pellets into capsules or beads 207. Where the gas injection process 206 can use any type of gas used for forming capsules 207 based on the requirement.

According to another exemplary embodiment of the present invention as shown in FIG. 3 describes about the method of preparing a green form polystyrene molding where a virgin expandable material 301 that can be a general purpose polymer (GPPS); virgin hardening polymer 302 where virgin hardening material can be an expandable polystyrene (EPS); recyclable expandable material 303 where the recyclable expandable material can be used polystyrene processed using process like extrusion process where the recycled polystyrene 303 can utilized or waste plastic like used bottles and thereof are mixed to form a compound mixture and other necessary recipes are also added to the compound mixture. Thereby the compound mixture is processed through extrusion process 304 to obtain MPS 305. Using gas injection technique 306 a blowing agent is injected into the MPS 305 to convert the pellets into capsules 307. Where the gas injection process 306 can use any type of gas used for forming capsules or beads 307 with desired properties based on the requirement. Thereafter we use pre-expander for pre-puffing 308 the capsules 307 to form a green form expandable polystyrene molding 309.

According to another exemplary embodiment, the method of preparing green form polystyrene further discloses composition of compounds to be used where desired quantities of the compounds mixed can be varied. Where the desired quantities can be in the range of following percentages whereby the general purpose polymer can be in the range 35 to 60, the expandable polystyrene can be in the range 1 to 20 and the recyclable polystyrene can be in the range 35 to 65.

According to another exemplary embodiment, the method of preparing green form polystyrene further discloses composition of compounds to be used where desired quantities of the compounds mixed can be varied. Where the desired quantities can be in the range of following percentages of general purpose polymer; expandable polystyrene; and the recyclable polystyrene can be varied from application to application based on the requirement. The ratio of percentage of virgin general purpose polymer, recyclable expandable material and expandable polystyrene contribute to increase in melt flow index of the green form polystyrene where the attained melt flow index can be more than 35 units and whereby varying the ratios in the mixture melt flow index can be varied where the melt flow index can be increased or reduced.

This invention promotes green technologies by the usage of recyclable plastic and also reduces the overall cost of the product. Because the cost of recyclable polystyrene is less when compared with virgin EPS or virgin GPPS. So recyclable polystyrene acts as a substitute to the virgin EPS and virgin GPPS whereby the amount of virgin EPS used in the production is of very less percentage.

The synthesized green polystyrene molded foam that can be used in different applications like insulation of walls, packaging, construction of buildings and thereof based on the requirement.

The green form polystyrene obtained have several advantages and improved properties like the overall cost of the production of green form polystyrene is very economical, the strength of the product obtained is high because of the molecular weight maintained, the overall thickness can be varied as required, whereby insulation properties are improved.

The green form expandable polystyrene can acts as a insulation means for sound and vibration, can acts as a flame retardant means, high power saving medium.

The other object of the present invention is to provide green form expandable polystyrene can acts as a power saving medium, power booster and thereof based on the requirement.

While we have shown and described only a few examples herein, it is understood that numerous changes and modifications as known to those skilled in the art could be made to the present invention. The scope of the present invention is not only limited to any particular industry and it can be applied or used in any other system within the spirit of the invention.

We claim:

1. Method of preparing green form polystyrene resin comprises of following steps
Mixing desired quantities of compounds comprising of virgin expandable material, virgin hardening polymer, recyclable expandable material and thereof; and
Extruding the mixture yields green form compounded polystyrene with high melt flow index.

2. Method of preparing green form polystyrene resin of claim 1; wherein virgin expandable material can be a general purpose polymer.

3. Method of preparing green form polystyrene resin of claim 1; wherein virgin hardening material can be expandable polystyrene.

4. Method of preparing green form polystyrene resin of claim 1; wherein recyclable expandable material can be used polystyrene processed using process like extrusion process.

5. Method of preparing green form polystyrene resin of claim 1; wherein desired quantities of the compounds mixed can be varied, where the desired quantities can be in the range of following percentages whereby the general purpose polymer can be in the range 35 to 60, the expandable polystyrene can be in the range 1 to 20 and the recyclable polystyrene can be in the range 35 to 65 whereby the desired properties of the green form polymer is attained as per usage.

6. Method of preparing green form polystyrene resin of claim 1; wherein ratio of percentage of virgin general purpose polymer, recyclable expandable material and expandable polystyrene contribute to increase in melt flow index of the green form polystyrene where the attained melt flow index can be more than 35 units and whereby varying the ratios in the mixture melt flow index can be varied where the melt flow index can be increased or reduced.

7. Method of preparing green form polystyrene beads comprises of following steps
Mixing desired quantities of compounds comprising of virgin expandable material, virgin hardening polymer, recyclable expandable material and thereof;
Extruding the mixture yields green form compounded polystyrene resin with high melt flow index; and
Gas injecting into the green form compounded polystyrene resin to synthesize green form expandable capsules or beads thereof with desired properties.

8. Method of preparing green form polystyrene molded foam comprises of following steps
Mixing desired quantities of compounds comprising of virgin expandable material, virgin hardening polymer, recyclable expandable material and thereof;
Extruding the mixture yields green form compounded polystyrene resin with high melt flow index; Gas injecting into the green form compounded polystyrene resin to synthesize green form expandable capsules or beads thereof with desired properties; and
Puffing expandable green form capsules with pre-expander to synthesize polystyrene molded foam which can be used for applications like insulation of walls.
